(19) United States
(12) Patent Application Publication
(10) Pub. No.: US 2013/0294745 A1
(43) Pub. Date: Nov. 7, 2013

(54) CREATION OF CUSTOMIZED/PERSONALIZED VIDEO FROM LARGE STOCK AUDIO/VISUAL DATABASES

(71) Applicants: Beilei Xu, Penfield, NY (US); Stuart A. Schweid, Pittsford, NY (US); Robert P. Loce, Webster, NY (US); Lee Anne Williams, Pittsford, NY (US)

(72) Inventors: Beilei Xu, Penfield, NY (US); Stuart A. Schweid, Pittsford, NY (US); Robert P. Loce, Webster, NY (US); Lee Anne Williams, Pittsford, NY (US)

(73) Assignee: Xerox Corporation, Norwalk, CT (US)

(21) Appl. No.: 13/462,867

(22) Filed: May 3, 2012

(51) Int. Cl. H04N 9/80

(52) U.S. Cl. 386/241; 386/E05.003

(57) ABSTRACT

The present application describes a method for the creation of customized/personalized videos and displays from stock audio/video databases that provide information in a particular subject area. The described method can be applied to many varied fields. For each field, a list of possible applications of customized videos is presented. The customized/personalized videos can be generated from a collection of stock video clips and personal data (i.e. databases) by: 1) collecting and establishing a stock information database 2) collecting personalized information/desired data; 3) parsing, sorting, and indexing stock video segments to meet a particular user's needs; 4) defining a workflow of the contents based on time, location, or cause-effect relationship of contents; and, 5) using video creation tools such as a scripting based approach (e.g., AVISynth©) and/or a playlist interface to stream or assemble the video clips.

### BACKGROUND

The present disclosure pertains generally to methods for creating electronic customized and personalized multimedia files, and more specifically to creating a personalized record and electronic file incorporating user-supplied and/or user-parsed digital images, information, data, and video combined with stock video footage, stock information (i.e., database), and/or synchronized further with audio recordings et al. The personalized record informs and educates the user, and provides a customized record to sort, review, and compare pertinent information.

Many online videos exist that educate and inform people on a wide variety of subjects, such as, healthcare, finance, education, home repair, tourism, real estate, leasing and travel. However, the information desired to be gained and used by watching a video and compiling data on a given subject will vary widely between viewers. For example, two families looking to purchase homes can watch a televised show on available properties, but the families may have different requirements concerning price range, schools, size of house and size of lot, etc. These two exemplary families currently need to watch many irrelevant video segments and review irrelevant information from extensive databases, and/or search the internet to glean their desired information (i.e. piecemeal) in a fractured manner.

What is needed is a cost-effective method to provide general and specific information that a person can (on demand) update, maintain, review, parse, sort, extract, access and/or share remotely with interested parties. The disclosure below describes a method for customizing and/or personalizing information directed toward particular subject matter that has pertinent usefulness to a particular user/searcher.

### SUMMARY

The present application describes a method for the creation of customized/personalized videos and displays from stock audio/video databases that provide information in a particular subject area. The described method can be applied to many varied fields, including: financial services, education, healthcare, purchasing, leisure/travel, et al. For each field, a list of possible applications of customized videos is presented. The customized/personalized videos can be generated from a collection of stock video clips and personal data (i.e. databases) by: 1) collecting and establishing a stock information database for an application including stock video clips, images, audio tracks, graphics, tables, etc. from available sources; 2) collecting personalized information/desired data from a graphical user interface (GUI) or a query based input system; 3) parsing, sorting, and indexing stock video segments to meet a particular user's needs; 4) defining a workflow of the contents based on time, location, or cause-effect relationship of contents; and, 5) using video creation tools such as a scripting based approach (e.g., AVISynth©) or a playlist rendering interface to stream or assemble the video clips.

The present disclosure provides a method of producing a customized record, comprising: incorporating prerecorded stock videos, stock information database, and one or more uncompleted segments for capturing personalized query information onto a single recording medium; providing the personalized query information including at least one customized segment extracted from the prerecorded stock videos and at least one customized segment extracted from the stock information database on a predeterminable subject; and combining the at least a portion of the prerecorded stock videos including the stock information database on the predeterminable subject with the customized information. The customized record can include portions of the prerecorded stock videos and portions of the stock information database that match a series of targets provided in the personalized query information and excludes portions of the prerecorded stock videos and portions of the stock information database that do not match a series of targets provided in the personalized query information. The customized record can further include scripting of the customized record for assembling the portions of the prerecorded stock videos and portions of the stock information database.

The present disclosure further provides a method of producing a customized record, comprising: incorporating prerecorded stock videos, stock information database, and one or more uncompleted segments for capturing personalized query information onto a single recording medium. The personalized query information can be inputted through a graphical user interface (GUI) and can include customized information extracted from the prerecorded stock videos and, the stock information database on a predeterminable subject; and can combine the at least a portion of the prerecorded stock videos including the stock information database on the predeterminable subject with the customized information. The customized record includes at least one insertion point within the uncompleted segments for inputting the personalized query information. The customized information includes portions of the prerecorded stock videos and portions of the stock information database that match a series of targets provided in the personalized query information and excludes portions of the prerecorded stock videos and portions of the stock information database that do not match a series of targets provided in the personalized query information. The customized record further includes scripting of the customized information for assembling the portions of the prerecorded stock videos and portions of the stock information database. The scripting can stream portions of the prerecorded stock videos.

The present disclosure still further provides a method of producing a customized record, comprising: incorporating prerecorded stock videos, stock information database, and one or more uncompleted segments for capturing personalized query information onto a single recording medium. The personalized query information can be inputted through a graphical user interface (GUI) and can include customized information extracted from the prerecorded stock videos and the stock information database on a predeterminable subject. The method further comprises sorting the at least a subset of the prerecorded stock videos including the stock information database on the predeterminable subject with the customized information. The customized record can include at least one insertion point within the uncompleted segments for inputting the personalized query information. The customized information can include subsets of the prerecorded stock videos and subsets of the stock information database that match a series of targets provided in the personalized query information and can exclude portions of the prerecorded stock videos and portions of the stock information database that do not match a series of targets provided in the personalized query information. The customized record can further include scripting of the customized information for assembling the subsets of the prerecorded stock videos and subsets of the stock information database. The scripting can establish the quantity and length of the subsets of the prerecorded stock videos and subsets of the stock information database streams the subsets of the prerecorded stock videos to be included in the customized record.

### BRIEF DESCRIPTION OF THE DRAWINGS

FIG. 1 shows, in highly schematic form, an outline of a personalized and customized record for presenting information for a predeterminable subject including parsed information therefor.

### DETAILED DESCRIPTION

The present application provides a framework for personalizing videos and databases for a variety of applications. The framework integrates relevant details for various applications, such as the rationale/usage of the video, personal information to be used in the video, sources of stock information, and the content/structure of the output video. Examples of broad areas (subjects) that are amenable to informing via video, are: real estate, travel, financial planning, college tours, education, purchasing, healthcare, pharmaceuticals, and physical therapy. As further described herein, the term ‘personalized’ electronic record or file refers to a customized compilation of information representing a subset of readily available information.

Many online videos and data sources exist that can educate and inform people on a wide variety of subjects, such as: healthcare, financial, education, home repair, and travel. However, the information desired to be gained by watching a video on a given subject will vary widely between viewers. For example, two diabetic patients trying to learn about proper management of their diabetes may need to see two very different videos. Proper diabetes management differs based upon the patient's current weight, medical conditions, diet restrictions and physical conditioning. These two patients would therefore each need to sift through many irrelevant videos to glean the right information that fits their personal needs.

The present disclosure provides a cost-effective way to provide general, specific, personalized, and customized information that a person can view multiple times and share with others and which includes only information pertinent (parsed) to their particular situation (i.e., search criteria). Hereinafter in more detail, a method is described for the creation of customized/personalized video and electronic video from stock of audio/video databases, along with other parsed data that provide particular information in a particular subject area. This method can be applied to many varied fields, including for example: financial services 100, education 200, housing/real estate 300, leisure/travel 400, and health/medical 500 et al. For each field, a list of possible applications of customized information is presented.

To be described in more detail hereinafter, the present disclosure provides a personalized record/electronic file, and method to produce the record/video, that combines stock tutorial record/video information with personalized information. Personalized information can include identification, inserted, overlaid, or parameterized information (still images, video, audio, text or graphics, etc.), historical sequence of images, subsets of databases, and sorted information conforming to a predeterminable script.

The present disclosure provides hardware apparatus, video stories, and methods whereby a pre-recorded stock video may be personalized by combining live or digitally captured images to segments of the pre-recorded stock video. In addition to personalized imagery, the system, which will subsequently be described in detail, is adaptable to the inclusion of personalized information, and additionally is capable of including captioning such as an individual's name or other information as part of the personalization of the underlying record.

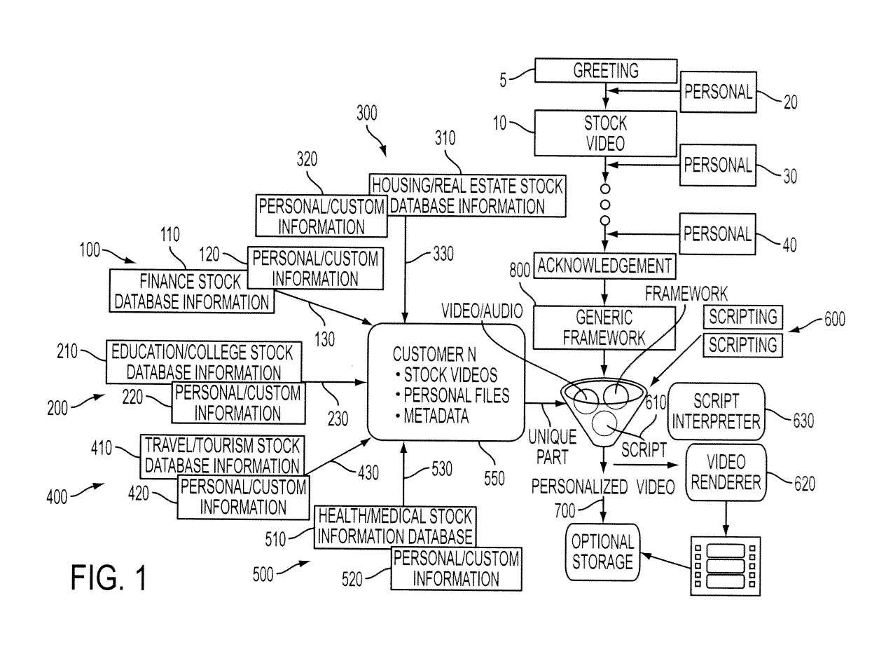

Referring to FIG. 1, there are several ways in which the personalized and/or customized record can be created. One could start with a greeting 5 and a standard stock video, prerecording, or record information 10. Stock or ‘canned’ videos 10 can be created in a manner that readily allows personalization, such as fixed, user data dependent, and/or predeterminable insertion points 20, 30, 40 between frames and within frames. The frames can allow for video, pictorial, textual, textural, and audio insertion. For example, blank areas can represent ‘blank canvas’ portions of the video or frames where information may be inserted, i.e. a greeting. There can be known portions of the video or frames where movement or other features can be varied, augmented, personalized, and/or edited, etc. There can be a graphical user interface (GUI) that prompts (and enables) a user to insert information in order to, for example, parse, sort or edit qualities and quantities of a feature. Additionally, information can be acquired from other query interfaces, such as, question and answer methods and/or database searches. The personalized electronic record/video can also be facilitated, for example, using components from a video scripting language 600 such as AVISynth®, where a script 610 can be either written directly or can be constructed from prompts as a GUI input or the query interface in possible combination with a playlist interface. The video can also be created using video editing software, such as Adobe After Effects®, or Microsoft Movie Maker®. Providing information and teaching material via video is a rapidly developing field. Several business services and personal services providers include video delivery of information. The information can include applications, workflow, capabilities and functionality.

As outlined above, the present disclosure comprises personalized electronic records/videos 100, 200, 300, 400, 500 and a method to produce the records/videos, that combines stock prerecorded files 110, 210, 310, 410, 510 with information personalized and customized 120, 220, 320, 420, 520 for a specific search along with an associated subset of parsed information. Personalized information can be inserted, overlaid, etc., and can include identification information, and parsed information (i.e., still images, video, audio, text or graphics, etc.) 130, 230, 330, 430, 530. One could start with a standard stock video which has been prerecorded or created in a manner that readily allows personalization, such as fixed, user data dependent, and/or predeterminable insertion points between frames and/or within frames.

Electronic files 550 can be created using a combination of stock video, personal information, and standard video editing tools. Additionally, one alternative method provides a mechanism where one or more stock videos and personal information can be assembled automatically. The method includes use of a GUI that allows specification of various parameters (e.g., search fields), specification of graphics and various information. It also can indicate insertion or modification points in the electronic file. As such, the two methods for creating the electronic file can include: (1) video and textual editing soft are and, (2) automated assembly.

In addition to image, video, text, graphic insertion or overlays, audio files can be parsed and sorted to further personalize and customize the video. The personalized record/video can be constructed by one of several methods. A manual-level user could write a script 610 that uses a video scripting language 600, such as AVISynth©. The script 610 can be automatically generated using information from the GUI (variables). Running the script 610 can play the video 620. Other manual creating methods can directly edit the video using video editing software, such as Adobe After Effects®.

In a more user-friendly system a video script 610 for consumption by a video rendering system 620 can be generated automatically using an interface program or script interpreter 630. The interface program would create a unique script by combining the user specific information parsed from a GUI, for example, presented to the user with a base or template script. The interface program 630 would use information from the GUI input to set a collection of pre-defined variables or parameters of the application as well as generate user-specific code for including or excluding particular sections or effects. One method for setting the variables needed by the user created script is to generate a separate file that simply contains variable assignment statements written in the video scripting language. This file is then incorporated into the user created script using an import/include type command.

The information from the GUI can be converted to parameters (e.g., location of the insertion or overlay, length of the insertion or overlay, appearance of the insertion or overlay) used by AVISynth©, for example, to assemble the script that produces the personalized record/video 700. Additionally, a playlist can also be used to combine the stock video segments with personalized segments rendered by the language.

In another arrangement, the method of producing a personalized record can comprise: incorporating at least a portion of a prerecorded stock tutorial video having stock information and one or more uncompleted segments for inserting personalized information queries into a single recording medium. The method can further comprise combining the at least a portion of the prerecorded stock tutorial video including the stock information on a variety of queries with the personalized information. The stock tutorial video can include at least one insertion point within the uncompleted segments for inserting the personalized information. The method still further comprises providing the personalized information at the at least one insertion point for merging with the at least a portion of the prerecorded stock tutorial video for producing at least a portion of the personalized record.

A general or generic framework 800 for generating customized/personalized videos from a collection of stock video clips and personal information can be described, in one exemplary arrangement, according to the following: collecting and establishing a stock information database for an application including stock video clips, images, audio tracks, graphics, tables, etc. from available sources; collecting personalized information/desire from a GUI or a query based input system; parsing and indexing stock information (e.g., video segments) to meet a particular user's needs; defining a workflow of the contents based on time, location, or cause-effect relationship of contents; and, using video creation tools such as a scripting 600 based approach (e.g., AVISynth©) to stream or assemble the video clips. Additionally, AVISynth© can be used in combination with a playlist interface for video aggregation. The framework can further comprise incorporating personalized segments into the customized record. The personalized segments 120, 220, 320, 420, 520 can be selected from the group consisting of: personalized audio tracks, annotated images, personalized graphs, personalized charts, and personalized videos.

Hereinafter, specific applications are described. For each application, a rationale and intended use is provided of personalized/customized video, the personalized information, stock information sources, and the output personalized/customized video output.

As an example, the creation of a personalized virtual college tour video 200 is described hereinafter. Choosing the right college is a very time consuming and stressful process for all parties involved: the students, their parents, and even the school counselor. It's a big decision for the family as it can have momentous impact on the family financial status, student's educational experience, and even their life and career in the future. Although many online virtual college tour videos 210 exist that describe the college, the details of a given student's specific needs and interests 220 are not incorporated into the videos.

Prospective students and their families still have to research and compare many colleges before they can narrow down their list of potential colleges to a manageable number that merit on-campus visits. This process is both time consuming and tedious. Additionally, with so much information to wade through it is very possible that the student may miss content that he or she is actually interested in seeing, which may impact the final decision.

To alleviate these problems, a method is presented for generating a customized/personalized virtual college tour video 200 assembled from existing stock videos 210 with customized/personalized information 220 based on a given student's specific needs and interests. It aids in the selection and decision process with visual and graphic information, which in turn can make the college search more efficient, less stressful and with better outcomes.

The tool can be used by both prospective students and their parents to scope out potential colleges, or by a school counselor for making recommendations by entering students' personal information to a GUI. The tool can be connected to a student database such as Naviance® to pull data directly. The personal information can include the student's grade/test scores, desired major/minor subjects, desired geographical regions, maximum tuition to be considered, interest level in fraternities/sororities, desired size of college, preference for private vs. state schools, gender, religious affiliation, housing requirements, campus setting (e.g., urban vs. suburb), sports and activities, degree granted, financial aid, etc.

Once the student's information and preferences are collected, the tool creates a virtual college tour video clip that introduces several colleges/departments that fit the profile of the specific student. For example, a prospective student who is interested in biology in the SUNY system in a suburb setting with a graduate program will receive a video that introduces the Department of Biology of SUNY Binghamton. The video starts with a greeting of the student by his/her current enrollment at the dept. of biology), followed by a selection of potential housing arrangements that fit the student profile, and the sports or other extra curriculum activities (e.g., dancing, drama, etc.) offered by the college that the student is interested in. The video can also include comparisons with a few other SUNY schools such as Stony Brook and SUNY Buffalo. The video will then end with a suggested itinerary (e.g., map of suggested places to visit, people to talk with, etc.) for an on-campus visit. The video can be viewed online, or delivered and viewed via a DVD. Its contents can be converted into audio/text files to be carried for the on-campus visit. The video can be created in the language based on the student's requirements.

The aforementioned method can be described, with an exemplary subject (i.e., college selection), as follows: selecting stock videos 210 that contain at least one customized segments 220 including specific interests in types of facilities (dorms, dining hall, etc.), department of major (facilities, curriculum, faculties, course descriptions, etc.), tuition/tuition aid/scholarships information, sports, clubs (drama, dance, etc.), local attractions (bars, entertainment venues), and religious services and activities; and where the selection of customized segments 220 based on student data uses at least one of grade, extra curriculum interests, geographic region, cost, major of study, size of school, gender, religious affiliation, housing options, campus setting, test scores, sports, and language. The stock tutorial video can include insertion points within the uncompleted segments for inserting the personalized student information. The personalized student information can be provided at the insertion points for merging with at least a portion of the prerecorded stock tutorial video for producing at least a portion of the personalized virtual college tour video. Providing the personalized student information can include: connecting to a student database, and/or, gathering student information from a GUI based on inputs from a student, student's parents, or student's counselors. Selecting stock video can include determining a number of customized segments based on required user's interests, and desired length (i.e. to control the length of the video). The personalized virtual college tour video can have the language of the video depends on user's choice. The customized segments can be ordered based on levels of interest, geographic location, time, and school highlights for producing the personalized virtual college tour video. The personalized virtual college tour video can have the audio track modified based on user's gender. The personalized student information can include comparing grade or standard test (e.g., AP, SAT, ACT, regents) against school population; displaying sports rankings against school division (e.g., I, II, III); comparing financial aid choices based on the student income data; and, showing course credits and requirements with student AP credits.

In addition to the creation of virtual college tour video, the process and method can be readily used to create other customized/personalized videos for information sharing in many other applications such as travel/tourism 400, financial planning 100, and housing/real estate 300.

Compared to conventional paper-based travel itineraries, video-based itineraries not only aid trip planning but also enhance travelers' experience with visual information that will familiarize them with their destinations before they actually travel. The video-based itinerary readily allows modifications such as inserting personalized data at fixed points between frames and points within frames. Additionally, audio can be easily altered and personalized and structures such as chapters can be included. After the trip is complete, travelers can insert, replace, and overlay their own videos and pictures into the video-based itinerary to make it a record of their travel experience.

Customer information can be collected via GUI inputs from either the customers themselves or from travel agents or an interview with a travel agent. The information can consist of one or more of the following: origin and destination, flight information, budget, dates/duration, members in group, preferences (e.g., food, transportation, hotels, points of interest based on age/gender), etc.

The stock video segments or information can be extracted from sources such as YouTube® Travelog, Rick Steves' TV programs of Tour of Europe, online bus/train/flight schedules, hotels, vendors (museums, stores, restaurants, etc.), government tourism websites, and government websites for travel documents, safety/security, and currency exchange.

Based on the customer information and preferences, the customized/personalized video-based itinerary can be created and a well laid out daily plan can be generated. The daily plan can provide travel suggestions and include pertinent travel planning information such as virtual maps with preferred routes highlighted, restaurant and local food choices, museum guide (e.g., virtual museum tour), hotel information (e.g., virtual tour of hotel rooms and surroundings), shopping, suggested points of interest, Google Street Walking Tour, night life choices, transportation choices/options/instructions, etc. Depending on the destination, the video can also include information of passport/visa/immunization requirements from government websites, local customs (tips, greetings, and communications), and any government issued safety/security warnings. The sequence of the video segments can be arranged according to time, location, or interests.

Financial planning can be used as another exemplary example of the aforementioned method. For most people any financial planning, from a simple car/home loan or health and life insurance to retirement planning or college financial aid calculation, can be overwhelming due to the complexity of the task and long term impact involved. Many financial products have terms that are difficult to understand and often they are printed in very small font that is difficult to read. Furthermore, there are often too many options to fully understand the implications/consequences of each one. A video-based financial planning guide can provide visual information and limit the amount of data presented to products that are applicable for the particular client. For example, college financial aid eligibility depends on gross household income, total assets, any scholarships awarded in the past, outstanding loans, etc. However, not every item on the list is applicable to every applicant. The personalized video will filter out irrelevant information, focus only on the information pertinent to the particular applicant, and provide a visual tool for how the aid can be calculated.

Customer information can be collected via GUI inputs from either the customers or any representatives. This information can consist of one or more of the following: age, gender, household income, current assets, household information such as number of people, job related information (e.g., type of job, years at job, any company benefits, targeted financial goals, etc.). The stock video segments or information can be extracted from sources such as financial institutions that sell various financial products such as insurance and mortgages or from colleges that provide grants, loans and other types of financial aid. Based on the customer information, the customized/personalized video-based financial information can be created for a set of products or one product at a time that may consist of choices of loans, comparisons of interest rates, terms from different types of loans, terms of the loan, etc.

Another application that can readily benefit from video-based customization/personalization is education, where from personalized lesson plans, tests, homework assignments, and course selections a video tailored to the specific student can be generated. The video might present suggested courses, recommended level of difficulty of course selection (e.g., honors or remedial), among other schedule recommendations. In some cases the video could address the requirements of special needs students and include information on available services such as speech therapy and occupational counseling, among others.

Customer information can be collected via GUI inputs from parents, teachers, and school counselors. This information can consist one or more of the following: age, gender, grade level, assessment information (state tests, IQ evaluation, any standard tests such as SAT, ACT), health information, teacher evaluation, any learning disabilities, etc.

Stock videos can come from online lesson plans, video tapes of a teacher's session, audio recordings of a student presentation, audio books, and even various educational videos. Based on the information, the customized/personalized lesson plan can consist of lessons on a particular topic such as fraction division (e.g., if weakness is shown on an exam) from visual examples (any manipulative used) to abstract representations, any audio aid for memorization, and follow-on practice problems.

Businesses that provide healthcare management services typically provide information such as suggested lifestyle changes, dietary programs, and provide professional consultation. Providing information on pharmaceutical services and pharmaceuticals is also one of the most important aspects of healthcare management services. For example, for patients with chronic conditions such as diabetes, encouraging patients to stay on their medication and maintain a healthy lifestyle is as important as the proper diagnosis and prescriptions. However, the fine-print text that often comes with the medication is hard to read and understand. Providing a customized/personalized video along with the prescription can visually help patients understand the importance of the drug to their specific condition, how and when to take their medication, any potential interactions with other drugs, and any potential side effects.

Customer information can be collected via GUI inputs by patients or their health care representatives, doctors, and pharmacists. This information can include the name of the medication, other medications the patient is currently taking, any allergies, and any other medical conditions that might be affected by this medication. The stock information can be from the manufacturer, the doctor, or the pharmacist in terms of video, audio, text, Physician's Desk Reference® for drugs, etc. The customized/personalized video can include customized/personalized segments on drug purpose, side effects, interactions, dosage, frequency, take with food/milk, cautions (machinery, driving, alcohol, etc.), refills, contact info (websites, doctor info, drug store number, etc.).

Another area in the healthcare arena that can benefit from having personalized information is physical therapy or exercise programs, as each person has different needs that personalized information and attention can help by encouraging patients to stay on the program longer.

Customer information can be collected via GUI inputs from patients, doctors, therapists, and instructors/coaches. The information can include the nature/purpose of the therapy/exercise program and the steps involved in the program. The stock information can be from exercise programs, equipment manufacturers, etc. The customized/personalized video can include customized/personalized segments on the exact movements in the program, frequency to be performed, any cautions, potential risks, etc.

The present disclosure is also suited for other applications (e.g., real estate) and can extend the information sharing into video format. Customer information can be collected via GUI inputs from the customer on the price range, location (city, town, distance to a certain landmark), type of neighborhood (young family, gated community, etc.), type of house (colonial, modern, ranch, condominium, etc.). The stock information can be extracted from online video listings, realtor's video/audio information of listings, Google street videos, videos of area school(s), etc. The customized/personalized video can include a virtual tour of multiple listings, the neighborhood and nearby attractions, virtual tour of area school(s), etc.

The purchase of large goods (e.g., cars and major appliances) can be a daunting task as there are so many choices in price range, features, and functionalities (e.g., mileage). Although not illustrated, a personalized video can provide visual information of a particular product, especially helpful when the product is in motion. Personal preferences can be collected from customer onsite inputs, purchasing history in terms of the preferred brand and price range, features (color, size, etc.,), mileage (car), delivery/pick up options, fixed price/bidding, etc. Stock videos can be collected from manufacturer websites, store websites, consumer reports, YouTube® video reviews, etc. The customized/personalized video can include a side-by-side comparison of different products in terms of price, ratings (product, store, etc.,), features, Energy Star®, warranty options, inside and outside appearance of the product, how the product is being used, etc.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A method of producing a customized record, comprising:
incorporating prerecorded stock videos, stock information database, and one or more uncompleted segments for capturing personalized query information onto a single recording medium;
providing said personalized query information including at least one customized segment extracted from said prerecorded stock videos and at least one customized segment extracted from said stock information database on a predeterminable subject;
combining said at least a portion of said prerecorded stock videos including said stock information database on said predeterminable subject with said customized record;
wherein said customized record includes portions of said prerecorded stock videos and portions of said stock information database that match a series of targets provided in said personalized query information and excludes portions of said prerecorded stock videos and portions of said stock information database that do not match a series of targets provided in said personalized query information;
said customized record further includes scripting or playlist generation of said customized segments for assembling included said portions of said prerecorded stock videos and included said portions of said stock information database;
wherein said scripting establishes the quantity and length of said portions of said prerecorded stock videos and portions of said stock information database streams said portions of said prerecorded stock videos to be included in said customized record; and,
wherein said scripting times said portions of said prerecorded stock videos and portions of said stock information database streams said portions of said prerecorded stock videos to be included in said customized record to control a desired length of said customized record.

2. The method of claim 1, further comprising:
incorporating a personalized segment into said customized record; and,
wherein said personalized segment is selected from the group consisting of: personalized audio tracks, annotated images, personalized graphs, personalized charts, and personalized videos.

3. The method of claim 2, wherein said providing said personalized query information is selected using a graphical user interface (GUI) and database search.

4. The method of claim 1, wherein said predeterminable subject is selected from the group consisting of tourism, financial planning, education, healthcare, real estate, home repair, leasing, and travel.

5. The method of claim 2, wherein said customized record includes at least one insertion point within said uncompleted segments for inputting said personalized query information; and,
capturing said personalized query information at said at least one insertion point for merging with said portions of said prerecorded stock videos for producing at least a portion of said customized record.

6. The method of claim 5, wherein said personalized query information is a collection of personalized inputs.

7. The method of claim 6, wherein said stock information database includes information selected from the group consisting of video clips, images, audio tracks, graphics, text, and tables.

8. The method of claim 7, further including preparing an edit list associated with said prerecorded stock videos for use in capturing said personalized query information.

9. A method of producing a customized record, comprising:
incorporating prerecorded stock videos, stock information database, and one or more uncompleted segments for capturing personalized query information onto a single recording medium;
providing said personalized query information including customized information extracted from said prerecorded stock videos and said stock information database on a predeterminable subject;
combining said at least a portion of said prerecorded stock videos including said stock information database on said predeterminable subject with said customized information;
wherein said customized record includes at least one insertion point within said uncompleted segments for inputting said personalized query information;
wherein said customized information includes portions of said prerecorded stock videos and portions of said stock information database that match a series of targets provided in said personalized query information and excludes portions of said prerecorded stock videos and portions of said stock information database that do not match a series of targets provided in said personalized query information;
said customized record further includes scripting or playlist generation of said customized information for assembling said portions of said prerecorded stock videos and portions of said stock information database; and,
wherein said scripting or playlist generation streams said portions of said prerecorded stock videos;
wherein said scripting establishes the quantity and length of said portions of said prerecorded stock videos and portions of said stock information database streams said portions of said prerecorded stock videos to be included in said customized record; and,
wherein said scripting times said portions of said prerecorded stock videos and portions of said stock information database streams said portions of said prerecorded stock videos to be included in said customized record to control a desired length of said customized record.

10. The method of claim 9, further comprising:
incorporating a personalized segment into said customized record; and,
wherein said personalized segment is selected from the group consisting of: personalized audio tracks, annotated images, personalized graphs, personalized charts, and personalized videos.

11. The method of claim 10, wherein said providing said personalized query information is selected using a graphical user interface (GUI).

12. The method of claim 10, further comprising:
wherein said predeterminable subject is education;
wherein said personalized query information is selected from the group consisting of age, gender, grade level, assessment information, test results, health information, teacher evaluation, and learning disability, including said targets therefor; and,
wherein said portions of said prerecorded stock videos and portions of said stock information database includes information selected from the group consisting of lesson plans, recommended course selections, material recommendations, and information on remedial services available.

13. The method of claim 10, further comprising:
wherein said predeterminable subject is travel;
wherein said personalized query information is selected from the group consisting of origin, destination, flight information, budget, dates of travel, number of members in travel group, and itinerary preferences; and,
wherein said portions of said prerecorded stock videos and portions of said stock information database includes information selected from the group consisting of travel suggestions, virtual maps, local food choices, destination guides, suggested points of interest, travel requirements, and security information.

14. The method of claim 10, further comprising:
wherein said predeterminable subject is financial planning;
wherein said personalized query information is selected from the group consisting of age, gender, household income, current assets, number of dependents, job information, and targeted financial goals; and,
wherein said portions of said prerecorded stock videos and portions of said stock information database includes information selected from the group consisting of choices for loans, comparisons of interest rates, terms of loans, and types of loans.

15. The method of claim 10, wherein said stock information database includes information selected from the group consisting of video clips, images, audio tracks, graphics, text, and tables.

16. The method of claim 15, further including preparing an edit list associated with said prerecorded stock videos for use in capturing said personalized query information.

17. A method of producing a customized record, comprising:
incorporating prerecorded stock videos, stock information database, and one or more uncompleted segments for capturing personalized query information onto a single recording medium;
providing said personalized query including customized information extracted from said prerecorded stock videos and said stock information database on a predeterminable subject;
sorting said at least a subset of said prerecorded stock videos including said stock information database on said predeterminable subject with said customized information;
wherein said customized record includes at least one insertion point within said uncompleted segments for inputting said personalized query information;
wherein said customized information includes subsets of said prerecorded stock videos and subsets of said stock information database that match a series of targets provided in said personalized query information and excludes portions of said prerecorded stock videos and portions of said stock information database that do not match a series of targets provided in said personalized query information;
incorporating a personalized segment into said customized record;
wherein said personalized segment is selected from the group consisting of: personalized audio tracks, annotated images, personalized graphs, personalized charts, and personalized videos;
said customized record further includes scripting or playlist generation of said customized information for assembling said subsets of said prerecorded stock videos and subsets of said stock information database; and,
wherein said scripting establishes the quantity and length of said subsets of said prerecorded stock videos and subsets of said stock information database streams said subsets of said prerecorded stock videos to be included in said customized record.

18. The method of claim 17, wherein said predeterminable subject is selected from the group consisting of tourism, financial planning, education, healthcare, real estate, home repair, leasing, and travel.

19. The method of claim 18, further comprising:
capturing said personalized query information at said at least one insertion point for merging with said portions of said prerecorded stock videos for producing at least a portion of said customized record.

20. The method of claim 19, wherein said stock information database includes information selected from the group consisting of video clips, images, audio tracks, graphics, text, and tables.

21. The method of claim 20, wherein said scripting edits said subsets of said prerecorded stock videos and subsets of said stock information database streams said subsets of said prerecorded stock videos to be included in said customized record.

22. The method of claim 21, wherein said scripting or playlist generation sorts said subsets of said prerecorded stock videos and subsets of said stock information database streams said subsets of said prerecorded stock videos to be included in said customized record.

23. The method of claim 22, wherein said scripting times said subsets of said prerecorded stock videos and subsets of said stock information database streams said subsets of said prerecorded stock videos to be included in said customized record to control a desired length of said customized record.
